(19) United States
(12) Patent Application Publication
(10) Pub. No.: US 2013/0206184 A1
(43) Pub. Date: Aug. 15, 2013

(54) MITIGATING SOLID ACCUMULATION ON A SUBMERGED SCREEN

(71) Applicant: SHELL OIL COMPANY, (US)

(72) Inventor: Sreekumar V. NAIR, Calgary (CA)

(73) Assignee: SHELL OIL COMPANY, Houston, TX (US)

(21) Appl. No.: 13/766,505

(22) Filed: Feb. 13, 2013

Related U.S. Application Data
(60) Provisional application No. 61/599,010, filed on Feb. 15, 2012.

(51) Int. Cl. B08B 3/02

(52) U.S. Cl. CPC B08B 3/024
USPC 134/34; 134/172

(57) ABSTRACT

Mitigating solid accumulation on a screen includes jetting water upstream through a portion of the screen while water simultaneously flows downstream through another portion of the screen. The water is jetted via at least one submerged nozzle. Several submerged nozzles may be present in an array on a moveable trolley. The submerged nozzles may be configured to provide warm or hot water or cold water having temperatures of less than 1° C.

### CROSS-REFERENCE TO RELATED APPLICATIONS

This application claims the benefit of U.S. Provisional Application No. 61/599,010 filed Feb. 15, 2012, which is incorporated herein by reference.

### FIELD OF THE INVENTION

The invention relates to a method of mitigating solid accumulation on a screen using submerged water nozzles.

### BACKGROUND

In refineries, plants, and other industrial operations that utilize large amounts of water, screens may be used at an intake point of the water from a nearby water source. These intake screens may prevent the passage of solids into the industrial operation, and may serve to protect environmental concerns, by preventing the passage of fish or other wildlife therethrough. Intake screens have proven effective at preventing the passage of fish, debris, silt, sediment, and other solids. However, accumulation of such solids on the screens may cause the screens to become blocked, reducing efficiency. For operations where a water supply is critical, a blocked screen can cause a shutdown of the entire operation until the screen can be adequately cleaned. Additionally, in cold regions with seasonal variations in temperature, particularly those climates where temperatures fall near or below the freezing point, frazil ice can also be a concern. Frazil ice has a characteristic that lends to crystal formation that can travel across a water stream, adhering to surfaces and growing in size, even against flow. In some instances, a seed of frazil ice may land on a screen and grow rapidly, causing blockage of the screen. It can be difficult to predict conditions amenable to frazil ice formation, making prediction of when a screen will be blocked, and the extent of such blockage even more difficult.

Some attempts to mitigate the drawbacks associated with the deposits of solids on screens have included compressed air backwash, low-pressure air bubblers, using various materials in construction or coating of the screen, frequent evacuation of sump water, heat trace or steam heating, and manual underwater cleaning. However, such methods have proven ineffective, economically infeasible, or both. Backwashing involves creating airflow in an upstream direction through the screen using compressed air, which cools the water around the intake screen further resulting in ice formation and screen blockage at lower water temperatures requiring cleaning downtime during the operation. Low-pressure air bubblers feed air through the screen at low pressure, with a tendency for the air to move unblocked areas, as those tend to be the points of least resistance. Changing the materials and/or coatings of the screen itself has proven ineffective, as the new screens may also be prone to blockage as microbial organisms start growing on the surface. Evacuation of the sump water to clean the intake screens by pumping back in to the river can create environmental issues resulting from the use of lubricants in the pumps in the sump. Heat trace and steam heating both require heaters, which may be costly to operate. Manual underwater cleaning involves sending divers into the water, which, in the case of frazil ice accumulation, can be very cold and dangerous to the divers.

Other designs have involved traveling screens, rotating circular screens, and multi-layer moveable screens. However, these designs can be complex and may have other limitations, such as requiring sufficient water depth, cleaning on a deck or pump house floor outside the water, which may be freezing. These designs also may require a fish return system, adding complexity.

### SUMMARY OF THE INVENTION

A method of mitigating solid accumulation on a screen may include jetting water upstream through a portion of the screen while water simultaneously flows downstream through another portion of the screen. The water may be jetted via at least one submerged nozzle.

An apparatus for mitigating solid accumulation on a screen may include a submerged nozzle configured to move water upstream through a portion of the screen, thereby mitigating solid accumulation. The nozzle may be disposed on a downstream side of the screen. During operation, water may move from the body of water on the upstream side of the screen, downstream through another portion of the screen at the same time as the nozzle moves water upstream through the first portion of the screen. The nozzle may be attached to a trolley configured to move the nozzle to another portion of the screen.

Another apparatus for mitigating solid accumulation on an upside side of a screen may include a nozzle configured to move water upstream through a portion of the screen. During operation, water may move from a body of water on the upstream side of the screen, downstream through another portion of the screen, at the same time as the nozzle moves water upstream through the first portion of the screen.

### BRIEF DESCRIPTION OF THE FIGURES

FIG. 1 is a perspective view of a partially cutaway screen and an apparatus for mitigating solid accumulation.

FIG. 2 is cross-sectional side view of a screen and an apparatus for mitigating solid accumulation.

### DETAILED DESCRIPTION

The present invention provides mitigation of solid accumulation on a screen via jetting water through the screen, in an upstream direction. The water used for jetting may be cold water from the same river source water supply for the industrial operation. The jetting may clean the screen by creating an upstream flow through a portion of the screen. While jetting is occurring, downstream flow may still pass through the screen, allowing for uninterrupted flow of water to an industrial operation from a submerged inlet source.

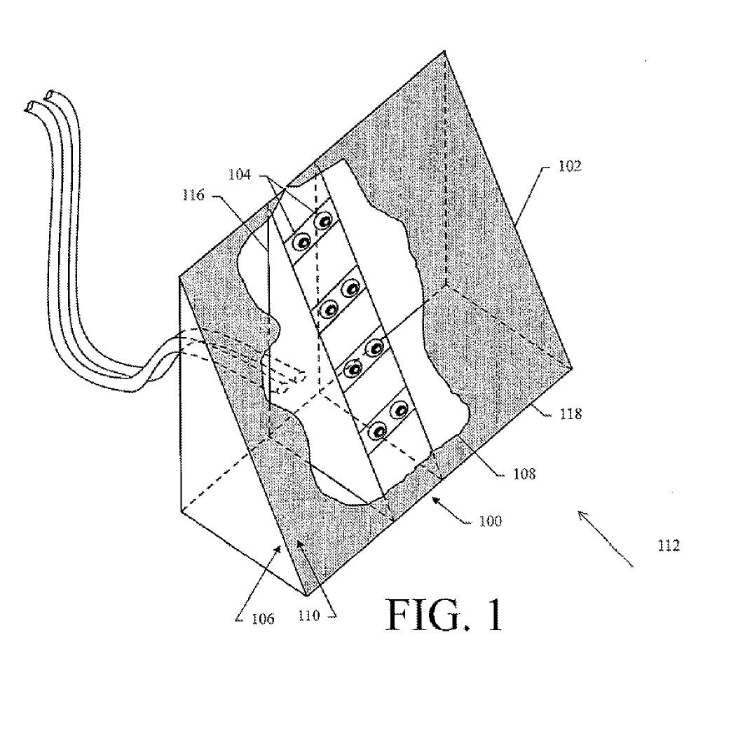

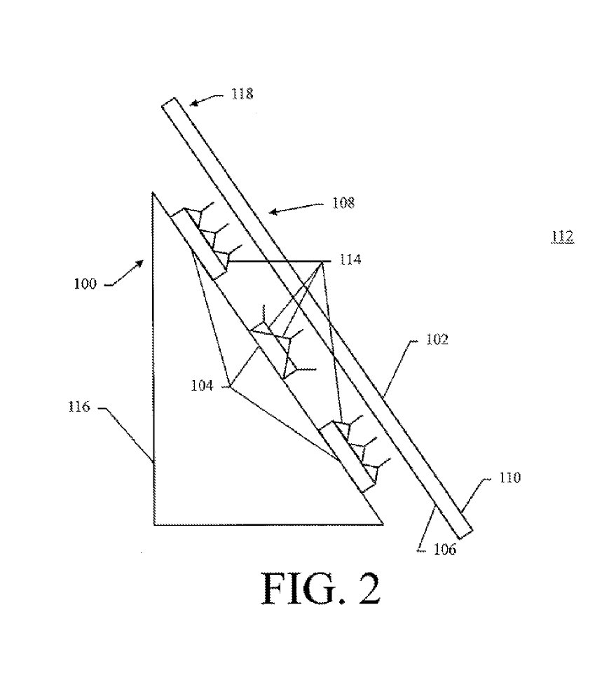

Referring now to FIGS. 1 and 2, an apparatus 100 is illustrated adjacent an intake screen 102. The apparatus 100 may include multiple nozzles 104 disposed on a downstream side 106 of the screen 102. The nozzles 104 may be configured to move water (warm or cold) upstream (i.e., in an upstream direction, from the downstream side 106 of the screen 102 to an upstream side 110 of the screen 102), through a portion 108 of the screen 102 proximate the nozzles 104. The movement of water upstream may be partially or wholly opposite in direction, or may merely counter a primary downstream flow direction (i.e., from the upstream side 110 of the screen 102 to the downstream side 106 of the screen 102). The upstream flow may allow for mitigation of solid accumulation on the upstream side 110 of the screen 102, particularly a portion 108 of the screen 102 proximate the nozzles 104.

The screen 102 may be a conventional screen, as is commonly used to prevent passage of solids or fish into an intake water supply of an industrial operation. For example, the screen 102 may be a trash screen with 4 inch opening to prevent debris intake, or the screen 102 may be an inclined stationary screen to prevent debris, silt, fish and ice (e.g., a screen manufactured by fish-pro), or the screen 102 may be a travelling screen to prevent fish entry. The material of construction of the screen 102 may include stainless steel mesh or buckets, depending on the screen design. Similarly, the opening shape and size may vary, based on application. Some screens may have openings sized to prevent entry of fish. Thus, the screen may have openings no larger than 1.25 mm. The screen 102 is generally submerged, such that it is below a water surface and functions to prevent the passage of solids through the screen 102. A body of water 112 may lie on the upstream side 110 of the screen 102. A portion of the body of water 112 may flow downstream through the screen 102, providing water supply to the corresponding industrial operation. The nozzles 104 may lie on the downstream side 106 of the screen 102 (i.e., on the side of the screen 102 opposite the flow from the body of water 112).

The nozzles 104 may provide a jet of water in an upstream direction, such that the water jet passes through the screen 102 in a direction contrary to a direction of flow from the body of water 112. The nozzles 104 may be of low pressure or high pressure depending on the application. The design of the nozzles 104 may vary to accommodate requirements regarding opening size, number of jets, coverage area, angle of installation and array, etc. The selection of material of construction for the nozzles 104 will generally be based on the quality of water where the screens 102 are used. Generally the nozzles 104 will have a stainless steel body with ceramic inserts 114 for underwater application, so as to provide better nozzle life. The nozzles 104 may not be currently available in the market, and may thus be manufactured based on the particular application. However it is thought that different types and size of inserts 114 may fit the nozzles 104 having different configurations. Therefore, the inserts 114 may be selected from different manufacturers or made to order and fitted in to the nozzles 104 based on location and performance required. The nozzles 104 may each have a stainless steel body machined to flat or conical or any suitable shape with provision to mount one or more ceramic inserts 114 inside a stainless steel cover duly threaded with fixtures for quick hose or pipe coupling. The nozzles 104 may jet water out constantly, intermittently, or in another predetermined manner. The nozzles 104 may have one or more inserts 114 designed to fit therein and further enhance flow from the nozzle 104.

The inserts 114 may fit in the nozzle 104 and may provide a reduced cross-sectional flow area as compared to an opening of the nozzle 104. The nozzle 104 may have one insert 114, or a plurality of inserts 114. When a plurality of inserts 114 are used, individual inserts 114 may point in a variety of different directions, providing a wider area of coverage for the nozzle 104. The inserts 114 may include a ceramic inner surface and a stainless steel threaded outer surface to engage the stainless steel nozzles 104, and facilitate mounting. The inserts 114 for high-pressure applications may be from 2 to 5 mm long with a 0.5 to 1.5 mm diameter. For low-pressure applications, the nozzles 104 may or may not use inserts 114. The inserts 114 could be located on the front end of the nozzle 104, which may have a flat surface or a conical surface. The location, size and inclination of the inserts 114 on the surface of the nozzles 104 are based on function. For example—a middle jet from the insert 114 of the nozzle 104 may be targeted to penetrate the bridged ice surface to start the clearing process. Circumferential jets from the insert 114 of the nozzle 104 may serve to widen the opening created by the middle jet, and may further serve to wash the ice away from the screen 102. The movement of the nozzle array may thus move the passive and washed away frazil ice or debris or silt along the direction of the river flow to carry it down stream of the screen 102.

The apparatus 100 optionally includes a trolley 116 that moves relative to the screen 102. The trolley 116 may move from one portion of the screen 102 to another portion of the screen 102, providing flexible treatment of the different portions of the screen 102. The trolley 116 may move on tracks, wheels, or otherwise, in a manner that allows the trolley 116 to provide the nozzles 104 in a location near the screen 102 in a portion for which treatment is desired. The trolley 116 may support the nozzles 104, which may be fixedly attached to the trolley 116. The trolley 116 may also have structure for delivering pressurized water to the nozzles 104. When desired, the trolley 116 may move at a preset speed, at a variable speed, or intermittently. As illustrated, the trolley 116 is sized to extend across the entire screen 102 and moves in two directions (i.e., on a z-axis). However, the trolley 116 could be smaller or larger than the respective dimensions of the screen 102. Additionally, the movement of the trolley 116 may not be confined to movement along one axis. Rather, with modification, the trolley 116 could also move along other axes. In fact, the trolley 116 could rotate or otherwise move in a countless number of directions with appropriate modification.

When activated, the apparatus 100 may mitigate solid accumulation on the upstream side 110 of the screen 102. As solid-laden water flows from the body of water 112, through the screen 102, the apparatus 100 may prevent solids from depositing on the upstream side 110 of the screen 102. Alternatively, or additionally, the apparatus 100 may clear away solids that have already deposited on the upstream side 110 of the screen 102. Whether preventing or removing solids from the screen 102, the nozzles 104 moves water upstream through the portion 108 of the screen 102 proximate the nozzles 104. Thus, any solids on the upstream side 110 of the screen and proximate the nozzles 104, but not yet deposited on the screen 102 may be moved away from the screen 102 before reaching the screen 102. Likewise, any solids previously deposited on the screen in the area treated by the nozzles 104 may be disengaged, removed, or cleared away from the screen 102. These solids may be jetted back in a direction further away from the screen 102 (e.g., toward the body of water 112), where they may be further moved away from the screen 102 by current, gravity, or otherwise.

The nozzles 104 may operate while water flows from the body of water 112 on the upstream side of the screen 102, downstream through a portion 118 of the screen unaffected by the nozzles 104. Thus, solids removal can occur while permitting the flow of water from the body of water 112 through the screen 102, toward the industrial operation. The apparatus 100 with the nozzles 104 that can operate while water flows in a contrary direction through the screen 102 may allow for an uninterrupted supply of water to the industrial operation (e.g. to a pump house facility). Various configurations may be used for causing the water to move downstream. For instance, a current present in the body of water 112, a pump, or gravity may provide motive force for the water passing through the screen 102. By cleaning, or otherwise mitigating solid accumulation on the screen 102 with the nozzles 104 having the configuration described, stoppages of water supply may be minimized as compared with other methods requiring unidirectional flow through the screen 102.

One method of mitigating solid accumulation on the screen 102 includes jetting water through the nozzles 104. Jetting refers to the forceful ejection, spraying, or otherwise rapid and/or low or high-pressure discharge of water from the nozzles 104. Some examples of nozzle distance, pressure, volume and coverage associated with jetting include (a) 400 mm, 3125 psi, 10.3 US gpm and 250 mm diameter; and (b) 200 mm, 1800 psi, 7 Us gpm and 125 mm diameter. Jetting water may occur via the nozzles 104, which are generally completely submerged below a surface of water in which the screen 102 is disposed. Jetting may involve moving water from the nozzles 104 in a direction substantially orthogonal to the portion 108 of the screen 102 proximate the nozzles 104 in stationary cleaning system. In a moving trolley design, the array of nozzles 104 moves along the length of the screen 102. In that situation, the jets from nozzles 104 that first come in contact with the screen 102 in the direction of travel will be tilted away in the direction of travel to effectively clear the screen. On the trolley's return travel, the other sets of nozzles 104 delivering jets are tilted away in the direction of travel to effectively clear the screen 102. As illustrated in FIG. 2, water may leave the nozzles 104 in a single direction, orthogonal, or tilted to the screen 102. However, depending on the configuration of inserts 114 in an array, water may alternatively leave the nozzles 104 in a plurality of directions. As illustrated, even when angles of discharge from the individual inserts 114 vary, they may still result in a nozzle with an overall discharge angle that is substantially orthogonal to the screen 102. The size, number, and position of the inserts 114 may be varied to meet specific conditions. For example, in some nozzle configurations, the trolley 116 may lie directly adjacent the screen 102, while in other configurations, the trolley 116 may allow for a small gap between the nozzles 104 and the screen 102. Such a gap may be advantageous when there are multiple angled pressurized solid water jets (or inserts 114) directed at the screen 102. For example, the gap between the nozzles 104 and the downstream side 106 of the screen 102 may be about 400 mm, and may mitigate solids in a portion of the screen 102 having a diameter of about 250 mm when solids are present in a small amount. When solids are more pervasive, the gap between the nozzles 104 and the downstream side 106 of the screen 102 may be about 100 mm, and may mitigate solids in a portion of the screen 102 having a diameter of about 50-100 mm. In one particular configuration, 64 nozzles may be provided in a fixed array (not shown) designed to cover the entirety of the screen 102, each nozzle having 4 inserts (e.g., 3 on the circumference and 1 in the middle). Such a configuration may omit the trolley 116. In an alternate configuration, 8 nozzles, each having 4 inserts, may be affixed to the trolley 116 and may move to cover the entirety of the screen. The inserts may be insulated and may be changed out to suit a specific application. The nozzles may have stainless steel fabrication, while the inserts may be ceramic formed within a stainless steel outer portion. Another alternate screen clearing design could involve installation of one or two rows of nozzles 104 on a horizontal trolley that is parallel to the inclined or straight river intake screen 102, where the nozzles 104 move up and down to cover the width of the screen 102 instead of the length. One example may use a row of 16 nozzles 104 tilted away from the direction of travel to effectively clear the screen 102. The trolley movement could be provided by a winch or chain drive or any other underwater drive system that is controlled typically by feedback loops. For example control feedback loops from location of the trolley, its travelling speed and end limits using different kinds of switches and sensors based on application.

Water used by the nozzles 104 may be provided by the same source of water as the flow downstream flow. For example, a body of water 112 may be the source for the water flowing through the screen 102 in both directions. Thus, the water jetted from the nozzles 104 may be cold water. For example, the water jetted from the nozzles 104 may be drawn from the body of water 112 or from a point downstream of the screen 102, without heating. The body of water 112 may include both manmade and natural sources such as a river, lake, pond, stream, etc. and, during the cold season, may have a temperature of about 0.1° C. to about 1° C., when clearing frazil ice may be desired. While frazil ice crystals begin to form in water between 0.1° C. and 1° C., water from an outdoor body of water may be used in the nozzles 104 at outdoor air temperatures as low as about −20° C. to about −25° C. Thus, in extreme cases, water having a temperature of less than 1° C., or even as low as 0.1° C. may be provided to the nozzles 104 for use in mitigation of solid accumulation. Also warm or hot water could be used to accelerate clearing of frazil ice during the cold season in applications where heat energy consumption is not a concern. However, in a warm climate, warm water through the same nozzles could be used to clear the intake screen.

Once the portion 108 of the screen 102 proximate the nozzle 104 has been sufficiently treated, the nozzles 104 may be deactivated, moved to treat another portion (e.g., the portion 118 of the screen previously unaffected by the nozzles 104) of the screen 102, or both. Whether through deactivation or movement, as soon as the nozzles 104 has stopped treatment of the particular portion (e.g., portion 108) of the screen 102, water may resume downstream flow through that portion of the screen 102.

The nozzles 104 may be partially or completely deactivated by restricting or otherwise controlling flow therethrough, such that jetting from the nozzles 104 is slowed or stopped. Such deactivation may occur when the presence of solids or the likelihood of solid accumulation has reached a sufficiently low level. When deactivated, the nozzles 104 may allow downstream flow through the screen 102, including the portion 108 proximate the nozzles 104. Deactivation of the nozzles 104 may be desired for various reasons. The nozzles 104 may remain deactivated for an extended time, such as during warm months where frazil ice is not a concern. The nozzle may remain deactivated for an intermediate time, such as during a time when solids have been sufficiently cleared from the screen 102 but are still being deposited. The nozzles 104 may be activated after a brief time of deactivation, such as during movement of the nozzles 104 from one portion of the screen 102 to another for immediate treatment. Regardless of the reason for deactivation, the nozzles 104 may be reactivated and used to treat another portion of the screen 102 or to re-treat the same portion of the screen 102. Further, nozzles may selectively operate, in either groups, or independent of one another, such that various nozzles may be activated and deactivated at will or in a predetermined manner. Likewise, nozzles may be moved in groups or independently, at will or in a predetermined manner.

When the nozzles 104 are moved without being deactivated, the nozzle 104 continues upstream flow through the screen 102. However, that upstream flow from the nozzles 104 no longer treats the initial portion of the screen 102, but may treat a new portion of the screen 102. Such movement (whether the nozzles 104 is briefly deactivated or not) may provide advantageous when solids are continuously presented to the screen 102. When the nozzles 104 are attached to the trolley 116, movement from one portion of the screen 102 to another may be assisted via movement of the trolley 116. For example, the trolley 116 may move in a direction parallel to the screen 102. Alternatively, or additionally, the nozzles 104 may move, relative to the screen 102 in any of a number of ways, including change in direction, rotation, or physical position of the nozzles 104. Thus, moving the nozzles 104 may involve any change in orientation of the nozzles 104 that would have a tendency to cause a different portion of the screen 102 to be treated by the nozzles 104.

Depending on the characteristics of the solid accumulation on the screen 102, the nozzles 104 may be moved at a constant speed, a variable speed, or intermittently. For example, when the trolley 116 travels in two directions (e.g., along a z-axis parallel to the screen), the speed of the trolley 116, and thus the nozzles 104, may vary at different points on the path of the trolley 116. For example, as the trolley 116 reaches one end of the screen 102 and reverses direction, the portion of the screen 102 most recently treated by the nozzle 104 would be the portion of the screen 102 proximate the nozzle 104 once again. In such instance, the trolley 116 may move quickly past that portion of the screen 102 to another portion of the screen 102 with more need of mitigation of solid accumulation. Likewise, depending on the rate of accumulation of solids on the screen 102, the nozzles 104 may be moved more rapidly, or more slowly, as conditions dictate. Thus, movement of the nozzles 104 may be maintained at a constant or a variable speed. The motion of the nozzles 104 may also be stopped and optionally restarted, as circumstances dictate. The nozzles 104 may be activated and deactivated during any of the stages of movement or lack thereof.

In addition to movement and activation selectivity, the output of the nozzles may be selected or adjusted to provide suitable solid mitigation while optimizing downstream flow through the screen 102. For example, the output of the nozzles may be limited by the flow rate of the regular flow through the screen. While a large number of nozzles may be useful for quickly cleaning the screen, it may not be desirable for the combined flow rate of the nozzles to exceed the regular flow rate through the screen. In other words, when flow to the industrial operation is uninterrupted, the volume of water flowing downstream through the screen 102 is necessarily more than the volume of water flowing upstream through the screen 102. Thus, there may be a minimum desired differential between the volume of upstream flow through the screen 102, caused by the nozzles 104, and the volume of downstream flow through the screen 102. This minimum differential may allow for sufficient downstream flow for industrial operations while providing sufficient upstream flow for effective mitigation of solid accumulation. In some instances, however, it may be desirable for the upstream flow rate to exceed the downstream flow rate. For example, when the screen is completely or almost completely blocked, flow from nozzles 104 may exceed downstream flow.

While the nozzles 104 are generally described as a singular element for simplicity, multiple nozzles may be used, as illustrated. The actual number of nozzles may be selected based on a number of factors, such as desired flow rates, coverage area required, ease of installation and maintenance, cost, trolley design 116 or other movement mechanism, low or high pressure application, warm or cold temperatures installation, etc. Further, the nozzles may have a variety of configurations, as dictated by the particular conditions of the screen and solids for which mitigation is desired. One such configuration involves a multiple array bank mounted on the trolley 116, to dislodge frazil ice and/or other debris deposited from the screen 102 against the underwater pressure and flow through the blocked screen, moving it downstream without any undue load on the screen 102 or affecting the environment in any way. This operation may keep fish away, mitigating the need for a fish return system.

The teachings herein may be used in a variety of situations with minor modifications. For example, the apparatus and methods described may be used in a variety of stationary or mobile underwater intake systems for cleaning purposes. Additionally, while the screen 102 was described as a conventional screen, broadly, a screen as used herein refers to a collection point for solids having two opposing sides. Thus, the methods and apparatus would also be equally suited for trash racks, and other points of solid accumulation as for conventional screens. Thus, the methods and apparatus described may be used to mitigate solid accumulation or otherwise treat the entire screen or any portion thereof.

What is claimed is:

1. A method of mitigating solid accumulation on a screen comprising:
jetting water, via at least one submerged nozzle, upstream through a first portion of the screen, while water simultaneously flows downstream through a second portion of the screen.

2. The method of claim 1, comprising moving the submerged nozzle.

3. The method of claim 2, comprising moving the submerged nozzle at a constant speed.

4. The method of claim 2, comprising moving the submerged nozzle at a variable speed.

5. The method of claim 2, comprising maintaining motion of the submerged nozzle.

6. The method of claim 2, comprising stopping motion of the submerged nozzle.

7. The method of claim 6, comprising restarting motion of the submerged nozzle.

8. The method of claim 1, wherein the water flowing downstream is provided by a body of water, the method comprising providing water from the same body of water to the submerged nozzle.

9. The method of claim 1, comprising providing water having a temperature less than 1° C. to the nozzle for jetting.

10. The method of claim 1, wherein the volume of water flowing downstream is greater than the volume of water flowing upstream.

11. The method of claim 1, comprising causing the water to flow downstream via pump.

12. The method of claim 1, wherein jetting water comprises moving water from the submerged nozzle in a direction substantially orthogonal to the first portion of the screen.

13. The method of claim 1, wherein jetting water comprises moving water from the submerged nozzle in a plurality of directions via an array of inserts.

14. An apparatus for mitigating solid accumulation on a screen comprising:
a submerged nozzle, disposed on a downstream side of the screen, and configured to move water upstream through a first portion of the screen, thereby mitigating solid accumulation;
wherein, during operation, water moves from a body of water, on the upstream side of the screen, downstream through a second portion of the screen, at the same time as the nozzle moves water upstream through the first portion of the screen.

15. The apparatus of claim 14, wherein the nozzle comprises a stainless steel body with provision to mount one or more ceramic inserts.

16. The apparatus of claim 14, wherein the nozzle comprises a plurality of inserts.

17. The apparatus of claim 16, wherein at least one of the inserts comprises a ceramic inner surface and a stainless steel threaded outer surface to facilitate mounting on the stainless steel nozzle.

18. The apparatus of claim 14, comprising a trolley, to which the submerged nozzle is attached, wherein the trolley is configured to move the nozzle to another portion of the screen.

19. An apparatus for mitigating solid accumulation on an upstream side of a screen comprising:
a nozzle configured to move water upstream through a first portion of the screen;
wherein, during operation, water moves from a body of water on the upstream side of the screen, downstream through a second portion of the screen, at the same time as the nozzle moves water upstream through the first portion of the screen.
